(19) United States
(12) Patent Application Publication
(10) Pub. No.: US 2026/0221128 A1
(43) Pub. Date: Jul. 30, 2026

(54) DEVICE INTERACTION METHOD AND APPARATUS, ELECTRONIC DEVICE, AND STORAGE MEDIUM

(71) Applicants: Shenzhen Large Magellan Technology Co., Ltd., Shenzhen (CN); Large Magellan Inc., Reno, NV (US)

(72) Inventors: Sen ZHANG, Shenzhen (CN); Nairen DAI, Shenzhen (CN)

(73) Assignees: Shenzhen Large Magellan Technology Co., Ltd., Shenzhen (CN); Large Magellan Inc., Reno, NV (US)

(21) Appl. No.: 19/232,744

(22) Filed: Jun. 9, 2025

(30) Foreign Application Priority Data
Jan. 26, 2025 (CN) 202510125269.0

(51) Int. Cl. G10L 13/027; G10L 17/02; G10L 17/04; G10L 17/06; G10L 17/22

(52) U.S. Cl. CPC G10L 13/027; G10L 17/02; G10L 17/04; G10L 17/06; G10L 17/22

(57) ABSTRACT

Embodiments of the present disclosure provide a device interaction method and apparatus, an electronic device, and a storage medium. The event information of the user interaction trigger event is obtained in response to the user interaction trigger event for the intelligent interaction device, where the profile of the intelligent interaction device is configured as the specific target role; the speech data of the target role for the user interaction trigger event is generated based on the event information by using the target language model corresponding to the target role, where the target language model is obtained through training based on both the role information and the dialog information of the target role; and the speech data is played based on the role attribute information of the target role by using the intelligent interaction device.

### CROSS-REFERENCE TO RELATED APPLICATION

This application claims priority to and the benefit of Chinese Patent Application No. 202510125269.0, filed on Jan. 26, 2025, the entire content of which is incorporated herein by reference in its entirety.

### TECHNICAL FIELD

The present disclosure relates to the field of artificial intelligence technologies, and in particular, to a device interaction method and apparatus, an electronic device, and a storage medium.

### BACKGROUND

With the rapid development of Internet technologies, artificial intelligence (AI) technologies are also widely applied. At present, most scenarios in which the AI technologies are applied on the market use the software of computers and mobile phones as carriers to interact with users, focusing on the office field or as a replacement for functions of the mobile phones.

It may be found in the research and practice process of the prior art that interaction between AI products and the users is still low in an existing interaction method based on the AI technologies, and the value that can be brought by the AI technologies cannot be exerted as much as possible, resulting in low device interaction efficiency.

### SUMMARY

Embodiments of the present disclosure provide a device interaction method and apparatus, an electronic device, and a storage medium, which can effectively improve an interaction effect between a user and an intelligent interaction device, thereby improving interactivity between an artificial intelligence product and the user, and further exerting a value brought by the AI technologies.

An embodiment of the present disclosure provides a device interaction method, including: obtaining, in response to a user interaction trigger event for an intelligent interaction device, event information of the user interaction trigger event, where a profile of the intelligent interaction device is configured as a specific target role; generating, by using a target language model corresponding to the target role, speech data of the target role for the user interaction trigger event based on the event information, where the target language model is obtained through training based on both role information and dialog information of the target role; and playing, by using the intelligent interaction device, the speech data based on role attribute information of the target role.

Correspondingly, another embodiment of the present disclosure further provides a device interaction apparatus, including: an obtaining unit for obtaining, in response to a user interaction trigger event for an intelligent interaction device, event information of the user interaction trigger event, where a profile of the intelligent interaction device is configured as a specific target role; a generating unit for generating, by using a target language model corresponding to the target role, speech data of the target role for the user interaction trigger event based on the event information, where the target language model is obtained through training based on both role information and dialog information of the target role; and a playing unit for playing, by using the intelligent interaction device, the speech data based on role attribute information of the target role.

Furthermore, yet another embodiment of the present disclosure further provides an electronic device, including a processor and a memory, where the memory is stored with a computer program, and when the computer program is executed by the processor, the processor is enabled to perform steps of any one of the device interaction methods provided in the embodiments of the present disclosure.

Furthermore, yet another embodiment of the present disclosure further provides a non-transitory computer-readable storage medium, including a computer program, where when the computer program is run on an electronic device, the computer program enables the electronic device to perform steps of any one of the device interaction methods provided in the embodiments of the present disclosure.

Furthermore, yet another embodiment of the present disclosure further provides a computer program product, including a computer program, where the computer program is stored in a computer-readable storage medium; and when a processor of an electronic device reads the computer program from the computer-readable storage medium, the processor executes the computer program to enable the electronic device to perform steps of any one of the device interaction methods provided in the embodiments of the present disclosure.

In the embodiments of the present disclosure, the event information of the user interaction trigger event is obtained in response to the user interaction trigger event for the intelligent interaction device, where the profile of the intelligent interaction device is configured as the specific target role; the speech data of the target role for the user interaction trigger event is generated based on the event information by using the target language model corresponding to the target role, where the target language model is obtained through training based on both the role information and the dialog information of the target role; and the speech data is played based on the role attribute information of the target role by using the intelligent interaction device. As such, the event information of the user interaction trigger event is obtained through the intelligent interaction device whose profile is configured as a specific target role, so that the speech data of the target role for the user interaction trigger event is generated based on the event information through the target language model corresponding to the target role, and the speech data is played through the intelligent interaction device based on the role attribute information of the target role. The user interaction trigger event can be responded to by using the target role, thereby effectively improving the interaction effect between the user and the intelligent interaction device, improving the interactivity between the artificial intelligence product and the user, and further effectively exerting the value brought by the AI technologies.

### DESCRIPTION OF THE DRAWINGS

In order to more clearly illustrate the technical solutions in embodiments of the present disclosure, the accompanying drawings depicted in the description of the embodiments will be briefly described below. It will be apparent that the accompanying drawings in the following description are merely some embodiments of the present disclosure, and other drawings may be obtained from these drawings without creative effort by those skilled in the art.

FIG. 1 is a schematic diagram of an implementation scenario of a device interaction method according to some embodiments of the present disclosure.

FIG. 2 is a schematic flowchart of a device interaction method according to some embodiments of the present disclosure.

FIG. 3a is a schematic diagram of an intelligent interaction device for a device interaction method according to some embodiments of the present disclosure.

FIG. 3b is a schematic diagram of a specific framework of a device interaction method according to some embodiments of the present disclosure.

FIG. 3c is a schematic diagram of another specific framework of a device interaction method according to some embodiments of the present disclosure.

FIG. 3d is an overall schematic flowchart of a device interaction method according to some embodiments of the present disclosure.

FIG. 3e is a schematic structural diagram of a base for a device interaction method according to some embodiments of the present disclosure.

FIG. 3f is a schematic structural diagram of another base for a device interaction method according to some embodiments of the present disclosure.

FIG. 3g is a schematic diagram of light effect setting for a device interaction method according to some embodiments of the present disclosure.

FIG. 3h is a schematic structural diagram of yet another base for a device interaction method according to some embodiments of the present disclosure.

FIG. 3i is a designing schematic diagram of a base for a device interaction method according to some embodiments of the present disclosure.

FIG. 3j is a designing schematic diagram of another base for a device interaction method according to some embodiments of the present disclosure.

FIG. 3k is a designing schematic diagram of yet another base for a device interaction method according to some embodiments of the present disclosure.

FIG. 4 is a schematic structural diagram of a device interaction apparatus according to some embodiments of the present disclosure.

FIG. 5 is a schematic structural diagram of an electronic device according to some embodiments of the present disclosure.

### DETAILED DESCRIPTION

Technical solutions in embodiments of the present disclosure will be clearly and completely described below in conjunction with drawings in the embodiments of the present disclosure. Obviously, the described embodiments are only a part of embodiments of the present disclosure, rather than all the embodiments. Based on the embodiments in the present disclosure, all other embodiments obtained by those skilled in the art without creative work fall within the protection scope of the present disclosure.

Meanwhile, in the description of the present disclosure, the term “first”, “second”, or the like are for distinguishing purposes only and are not to be construed as indicating or imposing a relative importance. Thus, a feature that limited by “first”, “second” may expressly or implicitly include at least one of the features. In the description of an embodiment of the present disclosure, the meaning of “plurality” is two or more, unless otherwise specifically defined.

Embodiments of the present disclosure provide a device interaction method and apparatus, an electronic device, and a storage medium. The device interaction apparatus may be integrated into an electronic device, and the electronic device may be a server, or may be a device such as a terminal.

The server may be a separate physical server, may be also a server cluster or a distributed system composed of a plurality of physical servers, or may be further a cloud server providing a basic cloud computing service such as a cloud service, a cloud database, a cloud computing, a cloud function, a cloud storage, a network service, a cloud communication, a middleware service, a domain name service, a security service, a content delivery network (CDN), and big data and an artificial intelligence platform. The terminal may include, but is not limited to, a figure, a mobile phone, a computer, an intelligent speech interaction device, an intelligent home appliance, a vehicle-mounted terminal, an aircraft, and the like. The terminal may be directly or indirectly connected to the server through wired or wireless communication, which is not limited herein.

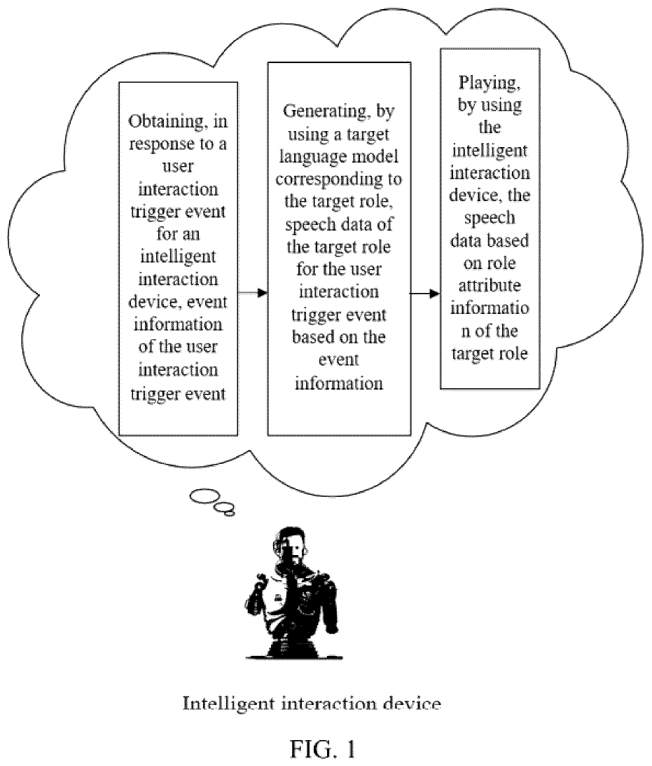

Referring to FIG. 1, an example in which the device interaction apparatus is integrated into the electronic device is taken. FIG. 1 is a schematic diagram of an implementation scenario of a device interaction method according to some embodiments of the present disclosure. The electronic device may be a terminal, and the electronic device may obtain, in response to a user interaction trigger event for an intelligent interaction device, event information of the user interaction trigger event, where a profile of the intelligent interaction device is configured as a specific target role; generate, by using a target language model corresponding to the target role, speech data of the target role for the user interaction trigger event based on the event information, where the target language model is obtained through training based on both role information and dialog information of the target role; and; and play, by using the intelligent interaction device, the speech data based on role attribute information of the target role.

It should be noted that the schematic diagram of the implementation environment scenario of the device interaction method shown in FIG. 1 is merely an example. The implementation environment scenario of the device interaction method described in the embodiments of the present disclosure is intended to more clearly illustrate the technical solutions in the embodiments of the present disclosure, and does not constitute a limitation on the technical solutions provided in the embodiments of the present disclosure. It will be appreciated by a person skilled in the art that the technical solution provided in the embodiments of the present disclosure is also applicable to similar technical problems with the evolution of the evolution of data processing and the emergence of a new service scenario.

The solutions provided in the embodiments of the present disclosure are specifically described by using following embodiments. It should be noted that the description order of the following embodiments is not intended to limit the preferred order of the embodiments.

The embodiments will be described from the point of view of the device interaction device, the device interaction apparatus may be specifically integrated into the electronic device, and the electronic device may be a terminal, which is not limited herein.

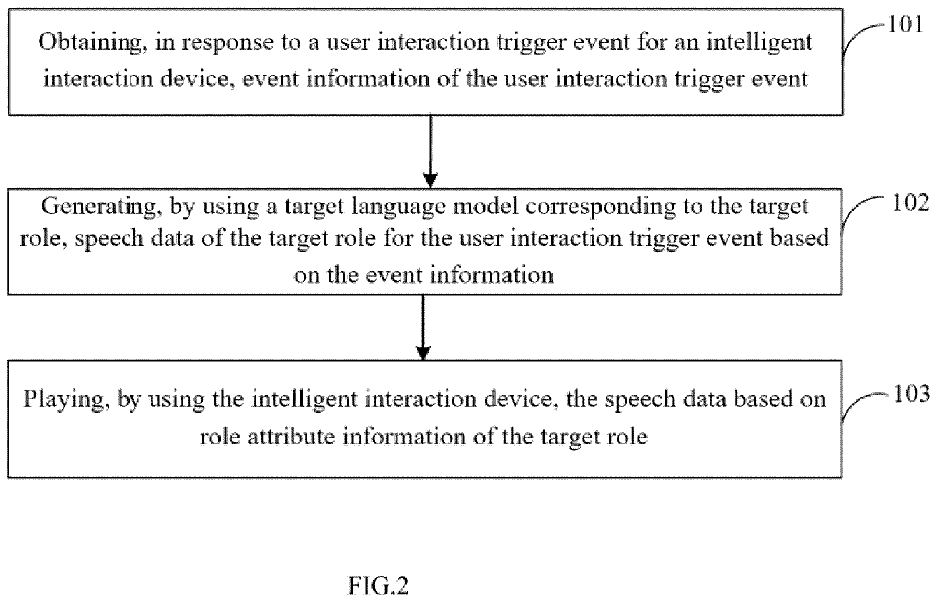

Referring to FIG. 2, which is a schematic flowchart of a device interaction method according to some embodiments of the present disclosure. The device interaction method may be applied to a target device, and the method includes following steps 101-103.

At step 101, event information of a user interaction trigger event is obtained in response to the user interaction trigger event for an intelligent interaction device.

A profile of the intelligent interaction device is configured as a specific target role.

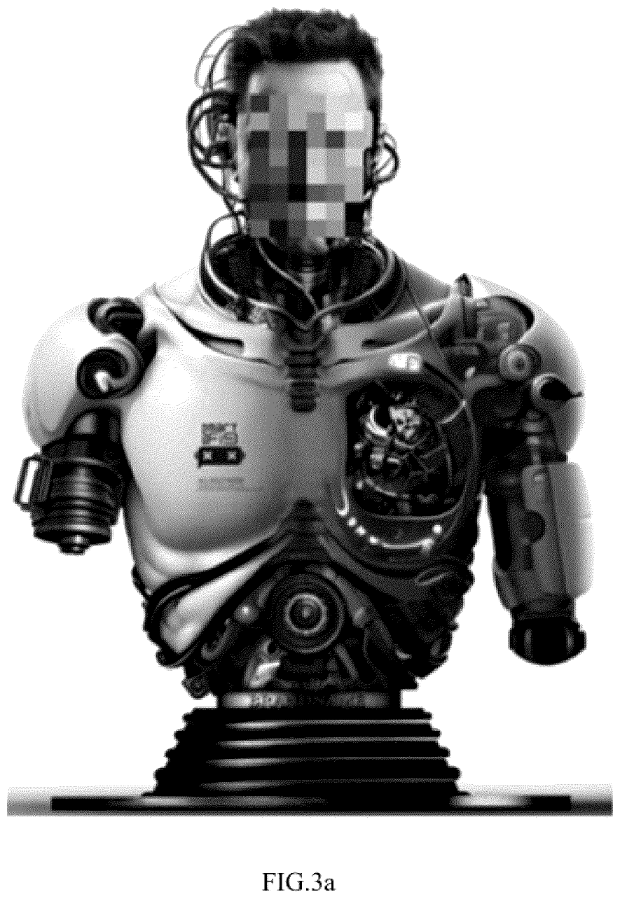

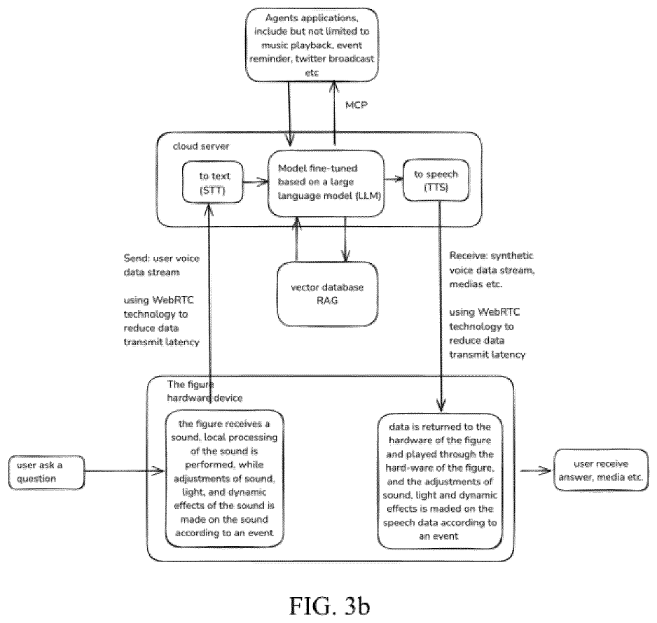

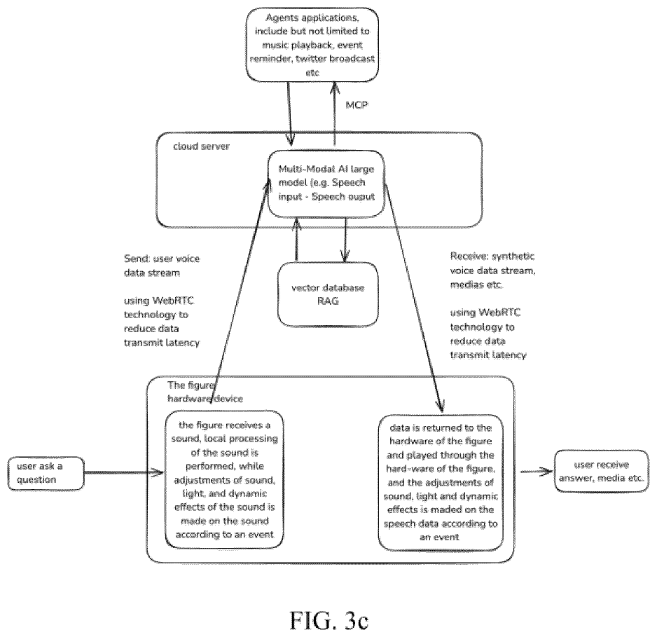

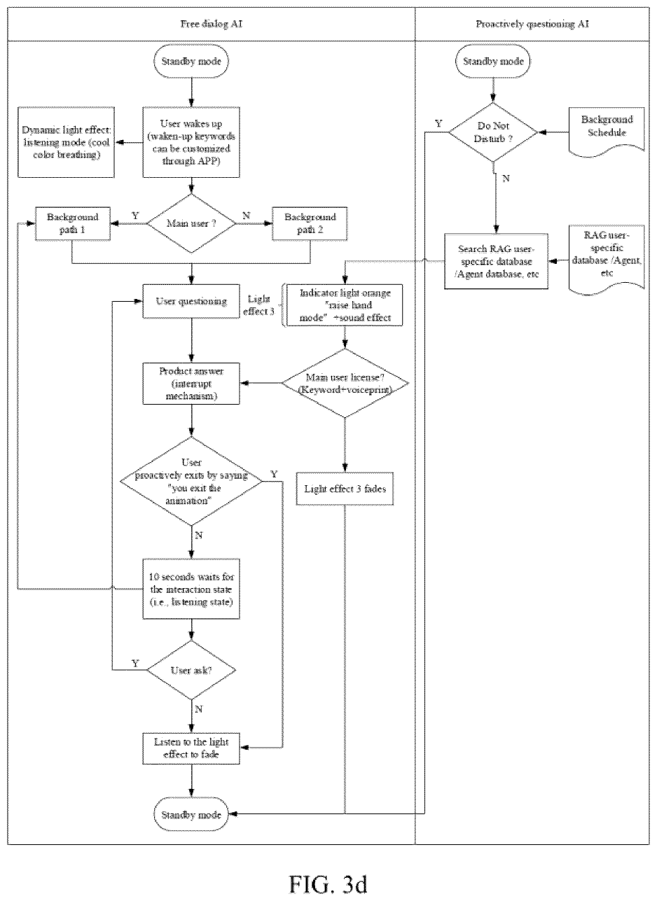

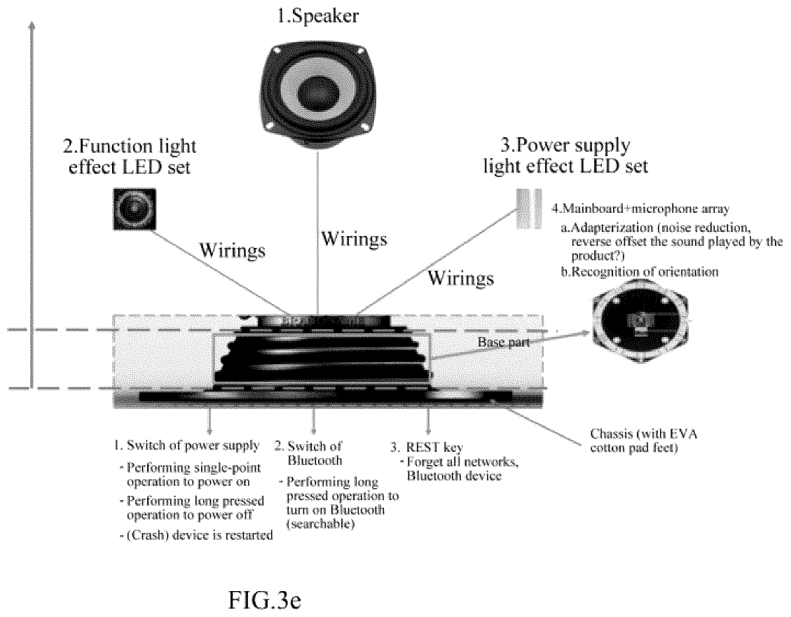

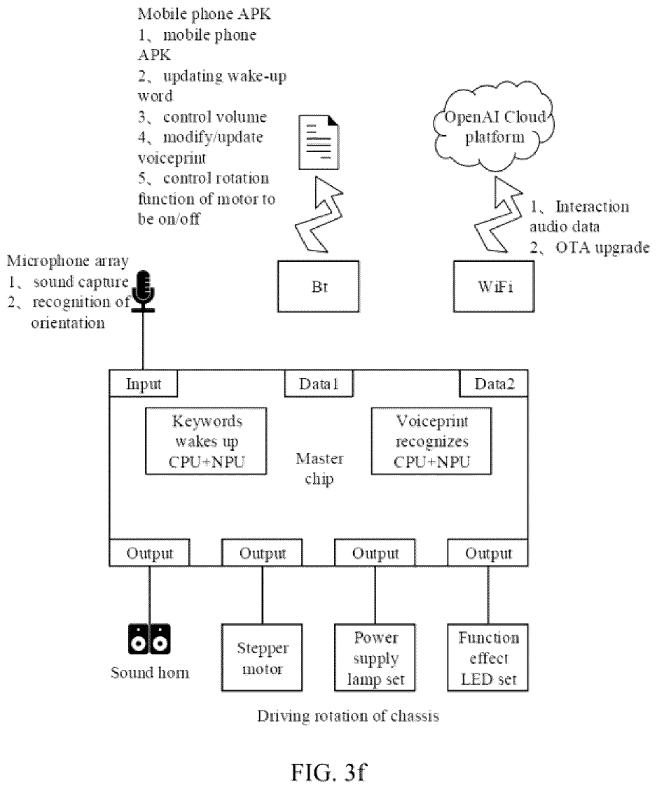

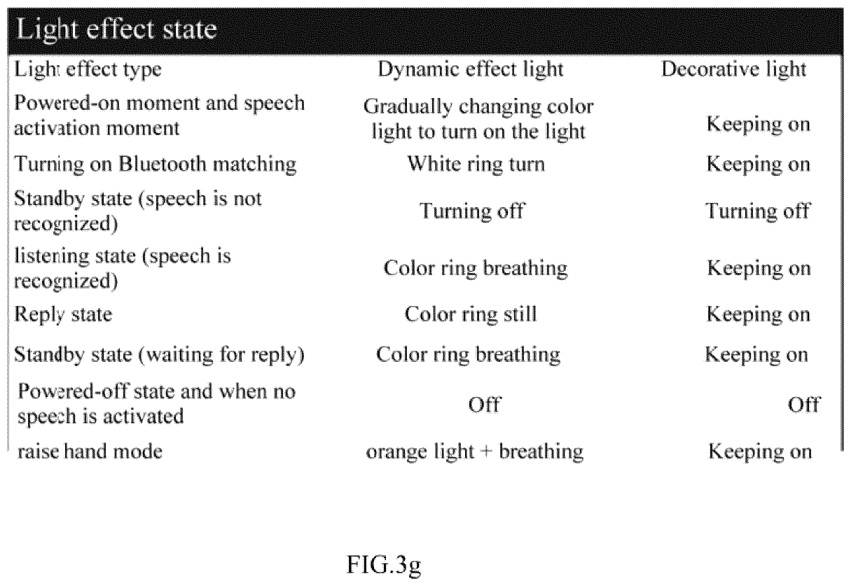

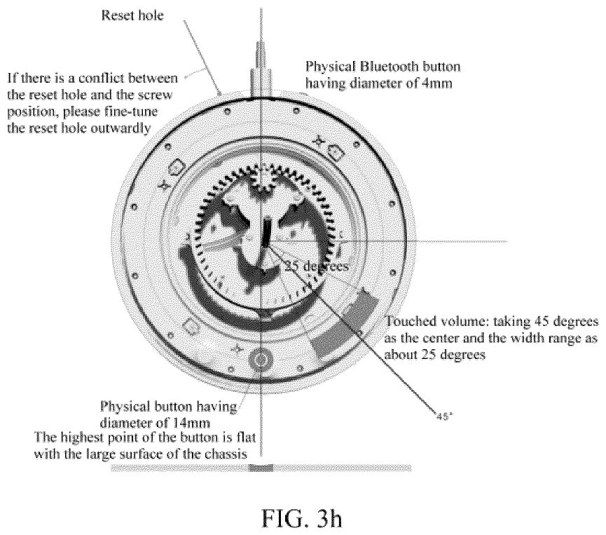

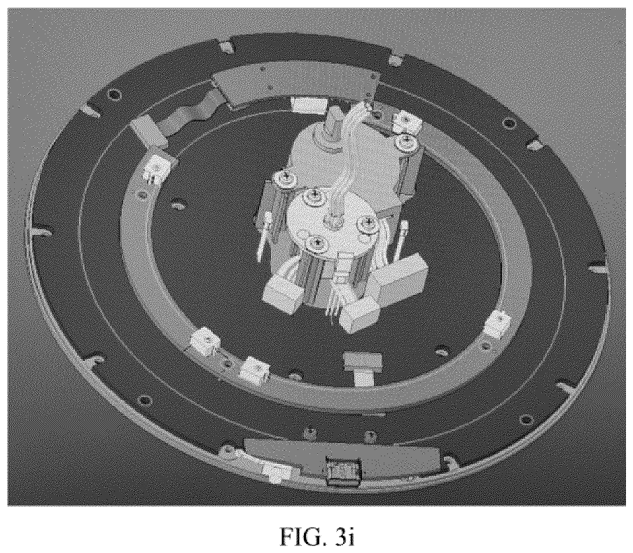

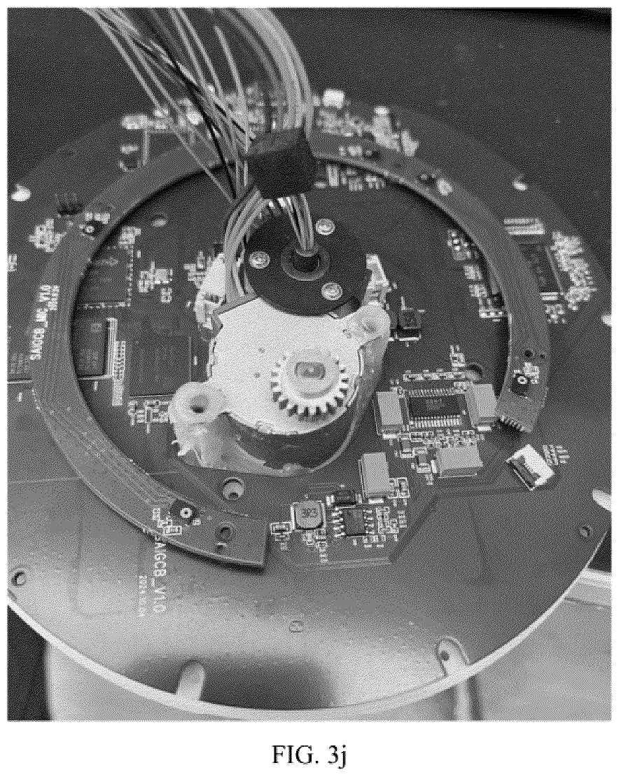

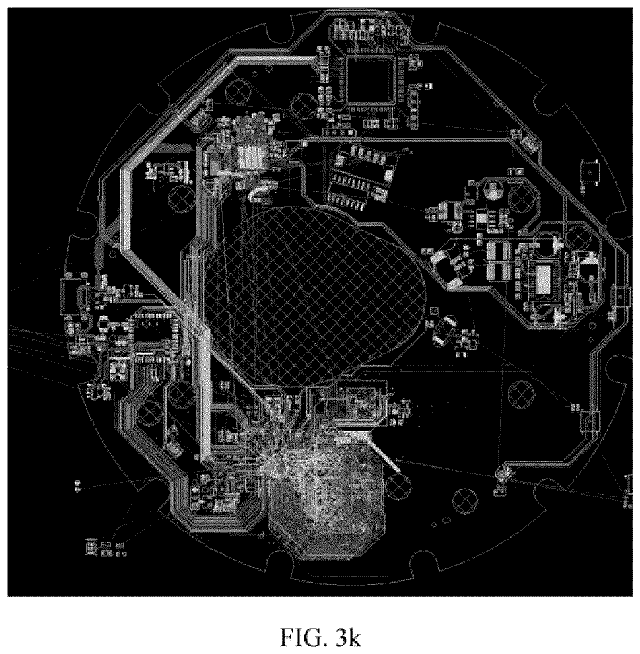

The intelligent interaction device may be a device that interacts with a user based on an artificial intelligence technology. For example, the intelligent interaction device may be a figure, that is, may be an intelligent speech interaction figure based on artificial intelligence (AI). The profile of the intelligent interaction device may be configured as a specific target role, where the target role may be a virtual role or an authorized real character. For example, the target role may include roles such as a heroic character, a cartoon role, a robot, and a virtual character. For example, referring to FIG. 3a, which is a schematic diagram of an intelligent interaction device of a device interaction method according to some embodiments of the present disclosure, the intelligent interaction device may be configured as a virtual role having a robot appearance.

The user interaction trigger event may be an event used to trigger the intelligent interaction device to interact with the user. For example, the user interaction trigger event may include a speech spoken by the user for interacting with the intelligent interaction device, or may include an interaction action generated by the user for the intelligent interaction device, or may include an event such as a preset reminder event being triggered for a reminder, or a wake-up event.

The event information may be information generated based on the user interaction trigger event. For example, when the user interaction trigger event is a speech spoken by the user for interacting with the intelligent interaction device, the event information may be speech data spoken by the user; when the user interaction trigger event is an interaction action generated by the user for the intelligent device, the event information may be action information of the interaction action generated by the user, where the action information may indicate an action performed by the user; and when the user interaction trigger event is a preset reminder event triggered for reminder, the event information may be related information of the reminder event, for example, may include an object related to the reminder event and other related information, and the object may be an object related to the reminder event, such a person or an animal, a plant, or the like, which is not limited herein.

Alternatively, the product layout of the intelligent interaction device may include two dimensions: a horizontal dimension and a vertical dimension, and may include product themes in the vertical aspect such as a game punk, a cartoon character, and a super hero. In the horizontal aspect, products of different roles may be laid out under each theme, and product designs of different roles are performed around the same theme. For example, taking a game punk theme as an example, a design concept of the game punk theme may be as follows: at the current outbreak of artificial intelligence (AI), thinking about the relationship between the highest possible form carriers [robot] and [human], the relationship between [intelligence] and [human nature], the relationship between [confrontation] and [symbiosis] after the highly evolved AI in the future, what will the future technology+people +social structure become? In this regard, the concept expression of this theme may be that the fusion expression of the real human skin texture and the mechanical nail style in a vector is a good ideal desire: harmony symbiosis. Therefore, for products under the theme of game punk, it is designed with the characteristics of the overall structure of disability+bare mechanical wind+scientific lighting+robot timbre.

At step 102, speech data of the target role for the user interaction trigger event is generated based on the event information by using a target language model corresponding to the target role.

The target language model is obtained through training based on both role information and dialog information of the target role. Specifically, the target language model can be obtained by fine tuning an underlying model based on the Artificial Intelligence Toolkit (OpenAI). For example, related information corresponding to the target role may be obtained as a training sample of the target language model. For example, information such as an interview video, an article, a self-introduction, a person experience, and a family background of the target role may be included as a training sample of a model, so as to fine-tune the model and customize a tone, a feature, a vocabulary, a person background, and a historical growth of the large language model, and implement a dialog of the target role by using the target language model.

The target language model may be a Large Language Model (LLM), the speech data may be data that the target role responds to the user interaction trigger event, and the role information may be related information of the target role. For example, the role information may include information such as, biography, personality, background, triview, thinking manner as well as conversation tone of the target role. The dialog information may be dialog content between the target role and another character. In this way, the target language model is obtained through training by using the role information and the dialog information of the target role, so that the trained target language model can learn a personality and a style of the target role, and a response of the target role to the user interaction trigger event can be simulated based on the target language model, thereby improving an interaction effect between the user and the intelligent interaction device.

Alternatively, the intelligent interaction device may upload the event information to the cloud to invoke the target language model corresponding to the target role, and generate, based on the input event information, the speech data of the target role for the user interaction trigger event.

There may be various ways to generate speech data of the target role for the user interaction trigger event based on the event information by using the target language model corresponding to the target role. For example, the user interaction trigger event may include the speech spoken by the user, and the obtaining of the event information of the user interaction trigger event may include: obtaining first speech data spoken by the user; and the generating of the speech data of the target role for the user interaction trigger event based on the event information by using the target language model corresponding to the target role may include: generating speech data for the target role responding to the first speech data based on the first speech data by using the target language model corresponding to the target role.

The first speech data may be data of the speech spoken by the user for the intelligent interaction device.

There may be a plurality of ways for generating the speech data for the target role responding to the first speech data based on the first speech data by using the target language model corresponding to the target role. For example, a dialog mode matching the first speech data may be recognized; if the dialog mode is a chat mode, extraction of a semantic feature is performed on the first speech data by using the target language model corresponding to the target role, to obtain the semantic feature; and the speech data for the target role responding to the first speech data is generated based on the semantic feature by using the target language model.

The dialog mode may be an interaction mode between the intelligent interaction device and the user. For example, the dialog mode may include a chat mode and an instruction mode, where, in the chat mode, the intelligent interaction device may have a free dialog with the user, and in the instruction mode, the intelligent interaction device may respond based on an instruction triggered by the user. The semantic feature may be information representing semantics of the first speech data.

For example, in the chat mode, the user can initiate a free conversation, so that the user can chat freely with the intelligent interaction device based on the target language model corresponding to the target role in combination with the attributes such as the corresponding target character, such as biography, background, triview, thinking manner as well as role tone of the target role. For example, when the target role is an enterprise role, the user may initiate a dialog: “Hi XXX, why will you create XXX Company?”, that is, the first speech data, so that the intelligent interaction device may generate and play speech data “Because I want to contribute to a future living space of a human, a risk resistance capability of all humans is improved. What do you think about the future living space of the human?” and the like.

In some embodiments, the user may actively request the intelligent interaction device to summarize and review important events within a specific time period. For example, the first speech data may be “reviewing big things happening in 2024”, so as to trigger the intelligent interaction device to summarize and reply based on the conversation content of the intelligent interaction device with the user in 2024 and the important moments at which the user requests the intelligent interaction product to remember. Specifically, extraction and analysis of information may be performed by using technologies including, but not limited to, a vector database, a traditional database, and a big language model, so as to generate and play speech data corresponding to the big things happened by the user in 2024.

Alternatively, there may be a plurality of ways for generating the speech data for the target role responding to the first speech data based on the first speech data by using the target language model corresponding to the target role. For example, a dialog mode matching the first speech data may be recognized; if the dialog mode is an instruction mode, instruction content in the first speech data is extracted based on the target language model corresponding to the target role, an instruction reply speech is generated based on the instruction content, and multimedia content indicated by the instruction content is obtained; and the speech data for the target role responding to the first speech data is generated based on the instruction reply speech and the multimedia content.

The instruction mode may be an instruction interaction mode, where in this mode, the intelligent interaction product has an AI instruction type function (Agents), the instruction content may be an instruction obtained from the first speech data, the instruction reply speech may be a speech generated for reply based on the instruction content, the multimedia content may be content such as music, news, and weather forecast, and the instruction may include playing music, broadcasting news, and inquiring weather.

There may be a plurality of ways of generating the speech data for the target role responding to the first speech data based on the instruction reply speech and the multimedia content. For example, the multimedia content may be converted into speech modal data, so that the speech modal data may be combined with the instruction replay speech to obtain the speech data for the target role responding to the first speech data.

For example, it is assumed that the user spokes a speech: “Hi XXX, play a piece of light music”, that is, the first speech data, so that the intelligent interaction device may obtain the instruction content “playing music” based on the first speech data, and may generate, in response to the instruction content, an instruction reply speech “playing XXX for you” based on the instruction content, and obtain music of a light music type indicated by the instruction content. Therefore, the intelligent interaction device may play the speech “playing XXX for you” and the corresponding music.

For another example, it is assumed that the user spokes a speech: “Hi XXX, what important news is in the technolog fieldy today?” Therefore, the intelligent interaction device may obtain an instruction content “playing news in the technology field” based on the speech spoken by the user, and may generate, in response to the instruction content, an instruction reply speech “collecting 10 big things in the technology field today for you” based on the instruction content, and obtain audio of the news in the technology field indicated by the instruction content. Therefore, the intelligent interaction device may play the speech “10 big things in the technology field today are collected for you” and broadcast the corresponding news.

Alternatively, there may be a plurality of ways for generating speech data for the target role responding to the first speech data based on the first speech data by using the target language model corresponding to the target role. For example, whether the user is a target user bound to the intelligent interaction device may be determined based on the first speech data; if the user is the target user, speech data for the target role responding to the first speech data is generated based on historical interaction data between the target user and the intelligent interaction device and the first speech data by using the target language model corresponding to the target role; and if the user is not the target user, speech data for the target role responding to the first speech data is generated based on the first speech data by using the target language model corresponding to the target role.

The target user may be a user bound to the intelligent interaction device, for example, may be an owner of the intelligent interaction device, or a main user, that is, a primary user. The historical interaction data may be interaction data between the target user and the intelligent interaction device in a historical interaction process. For example, the historical interaction data may include dialog data, instruction trigger and response data, and the like.

In this way, when the user is the target user, the response to the user may be generated more accurately based on a previously historical dialog between the target user and the intelligent interaction device by using the target language model, thereby improving interaction experience between the user and the intelligent interaction device and improving the intelligent interaction value of the intelligent interaction device.

There may be a plurality of ways to determine whether the user is a target user bound to the intelligent interaction device based on the first speech data. For example, voiceprint recognition may be performed on the first speech data to obtain first voiceprint information; second voiceprint information corresponding to the target user bound to the intelligent interaction device is obtained; and whether the user is the target user bound to the intelligent interaction device is determined based on the first voiceprint information and the second voiceprint information.

The first voiceprint information may be a voiceprint corresponding to the first speech data, and the second voiceprint information may be a voiceprint corresponding to the target user.

There may be a plurality of ways to determine whether the user is the target user bound to the intelligent interaction device based on the first voiceprint information and the second voiceprint information. For example, voiceprint comparison may be performed on the first voiceprint information and the second voiceprint information; if the first voiceprint information and the second voiceprint information belong to the same person, it may be determined that the user is the target user bound to the intelligent interaction device; and if the first voiceprint information and the second voiceprint information are relatively different from each other and do not belong to the same person, it may be determined that the user is not the target user bound to the intelligent interaction device.

In some embodiments, positioning of a sound source may be performed by using the intelligent interaction device, so that a position of a user to be interacted may be determined, to control the intelligent interaction device to face the user to be interacted, thereby improving a sound pickup effect and improving interaction experience between the user and the intelligent interaction device. Specifically, recognition of sound source orientation may be performed on the first speech data to obtain a sound source direction of the user; and the intelligent interaction device is controlled to face the user based on the sound source direction.

The sound source direction may be orientation of a user that spokes the first speech data.

There may be a plurality of manners of performing recognition of sound source orientation on the first speech data to obtain the sound source direction of the user. For example, the sound source orientation of the first speech data may be recognized by using a multi-microphone array to obtain the sound source direction of the user, so that, after the intelligent interaction device is woken up, the intelligent interaction device can turn to the sound source direction, that is, towards the user interacting with the intelligent interaction device.

Alternatively, in order to obtain a best speech-to-text (STT) effect, the intelligent interaction device may perform noise reduction processing on the collected first speech data, and when playing speech or music, the intelligent interaction product needs to ensure normal sound reception.

In some embodiments, the user interaction trigger event may include a preset reminder event, and the obtaining of the event information of the user interaction trigger event may include: obtaining at least one object related to the reminder event and historical memory information of the intelligent interaction device for the object. As such, the generating of the speech data of the target role for the user interaction trigger event based on the event information by using the target language model corresponding to the target role may include: generating the speech data of the target role for the user interaction trigger event based on the object and the historical memory information by using the target language model corresponding to the target role.

The historical memory information may be obtained based on data related to the object in historical interaction data between the user and the intelligent interaction device. The reminder event may be an interaction event actively initiated by the intelligent interaction device, the reminder event may be an event permitted by the user, and when the reminder event is triggered, the intelligent interaction device may be in a state of being woken up by the user, or may not be limited to be in a state of being woken up. The reminder event may include an anniversary reminder, a birthday reminder, an important event reminder, a memo event reminder, a weather change reminder, a festival reminder, a date reminder, and other events.

For example, the reminder event may include an important event of the user recorded according to past chat content at a specific time point, and the intelligent interaction device may actively initiate a conversation with the user based on the reminder event. For example, the intelligent interaction device may obtain event information corresponding to a reminder event for the third anniversary of an object A, so that the intelligent interaction device may be controlled to perform a raise hand action, and light up a corresponding light effect to play corresponding speed data: “According to a record of a past chat, tomorrow is the third anniversary when you meet the object A, and do not forget to give him a surprise.”

In some embodiments, the user interaction trigger event may include an interaction action generated by the user for the intelligent interaction device, and the obtaining of the event information of the user interaction trigger event may include: obtaining action information of the interaction action generated by the user for the intelligent interaction device. As such, the generating of speech data of the target role for the user interaction trigger event based on the event information by using the target language model corresponding to the target role may include: generating the speech data of the target role for the user interaction trigger event based on the action information by using the target language model corresponding to the target role.

The interaction action may be an action of interacting with the intelligent interaction device. For example, the interaction action may include: performing actions such as head touching, pressing, tapping, beckoning, and hand hearting on the intelligent interaction device. The action information may be information indicating the interaction action. For example, the action information may be an action name or an action identifier (ID) of the interaction action, and the like.

There may be a plurality of ways to generate the speech data of the target role for the user interaction trigger event based on the action information by using the target language model corresponding to the target role. For example, it is assumed that the interaction action is beckoning, which may indicate that the user is hailing to chat with the intelligent interaction device, the speech data corresponding to the target role may be generated based on the action information of the beckoning by using the target language model. For example, the speech data may be speech data, such as “What do you need me for, human” and “hello, I am”, and the intelligent interaction device may be controlled to perform the action of the beckoning. For another example, it is assumed that the interaction action is hand hearting, which may indicate that the user is showing the intelligent interaction device, speech data corresponding to target roles of different styles may be generated based on action information of the hand hearting by using the target language model. For example, the speech data may be speech data such as “Hum, cut it out” and “thank you, I also like you”, and the intelligent interaction device may also be controlled to perform an action of hand hearting.

In some embodiments, there may be a plurality of ways to generate speech data for the target role responding to the first speed data based on the first speed data by using the target language model corresponding to the target role. For example, device status information of the intelligent interaction device may be detected; the target language model matching the device status information is determined from a plurality of large language models for the target role; and the speech data for the target role responding to the first speech data is generated based on the first speech data by using the target language model.

The device status information may be information indicating a status of the intelligent interaction device, and the device status information includes at least one of posture information and device component assembly information of the intelligent interaction device. The posture information may be a role posture of the intelligent interaction device. For example, the posture information may include a posture made by the target role, such as raising a hand, making a fist, making a fork, lowering a head, bending a waist, and the like. The device component assembly information may be component assembly of the intelligent interaction device. For example, the device component assembly information may include carried assemblies such as a prop, a weapon, equipment, accessories, and clothing, and may further include a status such as a component being complete, a component being incomplete, and a component being aging, where the component being incomplete may mean that the target role corresponding to the intelligent interaction device misses a component such as an arm and a leg, and the component being aging may include states such as changing a hair color to white, and the equipment becoming old equipment.

Different device posture information can indicate different emotional states of the target role corresponding to intelligent interaction device. For example, when the intelligent interaction device makes the fist, it may indicate that the target role corresponding to the intelligent interaction device is in an emotional state of full confidence and excitement; when the intelligent interaction device lowers the head, it may indicate that the target role corresponding to the intelligent interaction device is in a low and sad emotional state; when the intelligent interaction device carries the prop, it may indicate that the target role corresponding to the intelligent interaction device is in an emotional state of tenacious struggle and not afraid of difficulties; and when the intelligent interaction device carries old equipment, it may indicate that the target role corresponding to the intelligent interaction device is in an emotional state of post-combat fatigue and pessimism, etc. In addition, different device posture information may indicate that the target role corresponding to the intelligent interaction device is in different life stages. For example, when the hair of the intelligent interaction device is black, it may indicate that the target role corresponding to the intelligent interaction device is in the young adulthood stage; and when the hair of the intelligent interaction device is white, it may indicate that the target role corresponding to the intelligent interaction device is in the old age stage. For another example, when the component of the intelligent interaction device is complete, it may indicate that the target role corresponding to the intelligent interaction device is in an optimistic ecology; and when the component of the intelligent interaction device is incomplete, it may indicate that the target role corresponding to the intelligent interaction device is in a pessimistic ecology.

Correspondingly, a plurality of large language models may be trained for the target role based on different ecology, emotional states, or life stages, and the different large language models may simulate dialog styles of the target role in different ecology, emotional states, or life stages. As such, the target language model matching the emotional state, or life stage, or ecology of device state information of the intelligent interaction device may be selected from the plurality of large language models corresponding to the target role based on the device state information, so that the speech data for the target role for responding to the first speed data in the corresponding state may be generated based on the first speed data by using the matched target language model. Therefore, the speech data responded to by the intelligent interaction device is more interesting and playable, thereby improving the interaction experience between the user and the intelligent interaction device.

At step 103, the speech data is played based on the role attribute information of the target role by using the intelligent interaction device.

The role attribute information may include attributes of the target role, such as sound, tone, intonation, personality, age, and gender. For example, the speech data may be played by using the sound of the target role through the intelligent interaction device. In this way, interaction between the target role and the user can be simulated by using the intelligent interaction device, thereby improving interaction experience between the user and the intelligent interaction device.

Alternatively, before the speech data is played through the intelligent interaction device, the intelligent interaction device may be controlled to perform a speech output prompt operation corresponding to the raise hand mode.

The raise hand mode may be a mode of controlling the intelligent interaction device to raise a hand, the speech output prompt operation may be an operation of prompting the user that the intelligent interaction device will output a speech, and the speech output prompt operation may include operations of controlling the intelligent interaction device to raise a hand, lighting up a light effect, making a sound effect, and the like. In this way, before the intelligent interaction device plays the speech data, the intelligent interaction device can be controlled to perform the speech output prompt operation corresponding to the raise hand mode, so that the user can be prompted that the interactivity between the user and the intelligent interaction device is improved, and the interaction experience between the user and the artificial intelligence product is further improved.

For example, an example in which the intelligent interaction device is figure is taken. Referring to FIG. 3b, which is a schematic diagram of a specific framework of a device interaction method according to some embodiments of the present disclosure. The user may ask a question for the intelligent interaction device, the figure may receive a sound, local processing of the sound is performed through hardware of the intelligent interaction device, while adjustments of sound, light, and dynamic effects of the sound may be made on the sound according to an event to obtain first speech data, and then the first speed data may be uploaded to a cloud server to perform speech to text (STT) processing on the first speech data through the cloud server, and then a reply text for responding to a text corresponding to the first speech data may be generated by using a model fine-tuned based on a large language model (LLM) corresponding to the target role, that is, a target language model, and a corresponding vector database or retrieval enhancement generation (RAG), so that text to speech (TTS) processing may be performed on the reply text to obtain and return speech data to the figure, the speech data is played through the hardware of the figure, and the adjustments of sound, light, and dynamic effects may be made on the speech data according to a play event.

Alternatively, the speech data corresponding to the first speech data may be directly generated by using a multimodal large language model. For example, referring to FIG. 3c, which is a schematic diagram of another specific framework of a device interaction method according to some embodiments of the present disclosure. The speech data for the target role responding to the first speech data may be output based on the input first speech data by using a multimodal AI large model corresponding to the target role.

Alternatively, while the speech data is played through the intelligent interaction device, the intelligent interaction device can be controlled to perform corresponding actions, so as to improve the interaction between the user and the intelligent interaction device. For example, the role posture information matching the speech data may be determined based on the role attribute information of the target role; motion control information of at least one part of the intelligent interaction device and/or device control information of a sub-device on the intelligent interaction device may be determined based on the role posture information; and when the speech data is played by using the intelligent interaction device, the intelligent interaction device is further controlled to move by using the motion control information and/or the device control information.

The role posture information may indicate information about a role posture of the intelligent interaction device, the role posture may include a posture such as making a fist, making a fork, bending a waist, beckoning, or rotating a circle, the part may include a part such as a hand, a leg, a waist, or a head of the intelligent interaction device, and the sub-device may include a device such as a light-emitting device, a heating device, or a ventilation device, which is assembled on the intelligent interaction device. The motion control information may be information for controlling the intelligent interaction device to move, and the device control information may be information for controlling the sub-device of the intelligent interaction device to run.

For example, when the speech data is “very sorry, I don't notice your requirement”, the role posture information may be bending waist, and the motion control information may be information for controlling the intelligent interaction device to bend waist, so that the intelligent interaction device may be controlled to bend waist while the intelligent interaction device plays the speech data. For another example, when the speech data is “good, we work together”, the role posture information may be making the fist, and the motion control information may be information for controlling the intelligent interaction device to make the fist, so that the intelligent interaction device may be controlled to make the fist while the intelligent interaction device plays the speech data. A specific control rule may be set according to an actual situation, and is not limited in the embodiments of the present disclosure.

In some embodiments, the intelligent interaction device provided in the embodiments of the present disclosure may serve as a general control terminal of the intelligent home device, and may control a connected intelligent home device based on an indication of a user. Specifically, an intelligent home device required to be controlled and a control parameter corresponding to the intelligent home device may be determined based on the event information, so as to control the intelligent home device required to be controlled based on the control parameter.

For example, when the user generates the first speech data “turning on the air conditioner and setting the temperature to be 26 degrees” for the intelligent interaction device, based on the first speech data, the intelligent interaction device may determine the intelligent home device required to be controlled “air conditioner” and the control parameter corresponding to the intelligent home device “turning on” and “26 degrees”, so that the speech data “OK, right away” may be played, and the intelligent home device “air conditioner” may be controlled to be turned on based on the control parameter, and a cooling temperature of the air conditioner may be set to 26 degrees.

For another example, when the user generates the first speech data “turning on a light in a living room” for the intelligent interaction device, based on the first speech data, the intelligent interaction device may determine the intelligent home device “the light in the living room” required to be controlled and the control parameter “turning on”, so that the voice data “OK, turn on the light in the living room” may be played, and the intelligent home device corresponding to the light in the living room may be controlled to be turned on based on the control parameter.

In some embodiments, the user may interrupt when the intelligent interaction device plays the speech data, to more accurately and truly simulate a real-person dialog scenario, thereby further improving interaction experience between the user and the intelligent interaction device. For example, if it is detected that the user has an interruption behavior for the speech data when the speech data is played through the intelligent interaction device, second speech data generated by the user based on the interruption behavior may be obtained; target speech data for the target role responding to the second speech data is generated based on the played data in the speech data and the second speech data by using the target language model; and the target speech data is played by using the intelligent interaction device.

The interruption behavior may be a behavior of interrupting the intelligent interaction device to play the speech data, and the second speech data may be an interaction speech spoken by the user after interrupting the intelligent interaction device to play the speech data. The target speech data may be data that is generated by the target language model based on the played data and the second speech data and that responds to the second speech data.

For example, when the intelligent interaction device locally plays the speech data returned by streaming through a speaker, if the speech is interrupted by the user during a speech playing process, playing of the speech may be immediately stopped, and the next listening mode is entered, so that the second speech data spoken by the user may be collected, and the played speech data and the second speech data that the user continues to ask for may be returned to the cloud together, so as to perform the next dialogue by using the target language model. In this way, interaction experience between the user and the intelligent interaction device can be improved.

In some embodiments, referring to FIG. 3d, which is an overall schematic flowchart of a device interaction method according to some embodiments of the present disclosure. the intelligent interaction device may have the ability to talk freely and ask questions proactively. For the talking freely, when the intelligent interaction device is woken up by the user, it may be determined whether the current user is a primary user, so as to execute different background paths, and when the user asks questions, an answer may be made based on a speech asked by the user, and a corresponding dynamic effect, light effect, and the like are enabled. When the user actively exits, the intelligent interaction device may wait for 10 seconds, and if the user does not continue to query, the user may control the listening light to gradually turn off, thereby entering a standby state. For the asking questions proactively, a database such as a RAG user-specific database or an AGent may be retrieved at a non-do-not-disturb time, or a reminder event may be triggered by using a program preset in the background, so that an active dialogue may be performed with the user.

In some embodiments, the intelligent interaction device may be rotated. For example, the rotation of the intelligent interaction device may be implemented through a base design of the intelligent interaction device. Specifically, referring to FIG. 3e, which is a schematic diagram of a base structure of a device interaction method according to some embodiments of the present disclosure. A speaker, a function light effect LED group, a power supply light effect LED group, a mainboard, a microphone array, and various switches and keys may be configured in the base of the intelligent interaction device, to implement functions such as sounding, light emission, and rotation of the intelligent interaction device. Meanwhile, the role model of the target role can be placed on the base, so that the profile of the intelligent interaction device can be configured as the target role.

In some embodiments, referring to FIG. 3f, which is a schematic diagram of another base structure of a device interaction method according to some embodiments of the present disclosure. As shown in FIG. 3f, a main chip of an intelligent interaction device may control a wake-up word, a volume, a voiceprint, a rotation, an on/off state, and the like of the intelligent interaction device by using a mobile phone application package (Android application package, APK for short). Specifically, the main chip of the intelligent interaction device may capture, based on a microphone array, speech data generated by a user, so as to trigger, based on the speech data, control of a speaker, a stepper motor, a power lamp group (that is, a power lamp effect LED group), and a function effect LED group (that is, a function lamp effect LED group) of the intelligent interaction device, to implement interaction control on the intelligent interaction device, and may further interact with a cloud platform by using a wireless network (WiFi), to obtain reply speech data and the like.

In some embodiments, referring to FIG. 3g, which is a schematic diagram of setting a light effect of a device interaction method according to some embodiments of the present disclosure. The intelligent interaction device may be provided with corresponding light effects in different states, where types of the light effects may include types such as a dynamic light and a decorative light. For example, at a startup moment and a speech activation moment of the intelligent interaction device, the dynamic light of the intelligent interaction device may be controlled to generate an effect of gradually changing color light to turn on the light and keep the light to be in a turned-on state while the decorative light may be controlled to be in a turned-on state, so that an interaction effect of the intelligent interaction device may be improved.

Alternatively, referring to FIG. 3h, which is a schematic structural diagram of yet another base for a device interaction method according to some embodiments of the present disclosure. Correspondingly, an embodiment of the present disclosure further provides a corresponding circuit board design diagram. For example, referring to FIG. 3i, which is a designing schematic diagram of a base for a device interaction method according to some embodiments of the present disclosure. Correspondingly, referring to FIG. 3j, which is a designing schematic diagram of another base for a device interaction method according to some embodiments of the present disclosure, which shows a specific circuit board of the intelligent interaction device provided in the embodiments of the present disclosure. Correspondingly, referring to FIG. 3k, which is a designing schematic diagram of yet another base for a device interaction method according to some embodiments of the present disclosure, which shows a circuit design diagram of a base circuit board of the intelligent interaction device provided in the embodiments of the present disclosure.

With the explosive development of the AI technologies, artificial intelligence has entered the field of view of ordinary people. However, at present, most scenarios in which the AI technologies are applied on the market are only micro-innovation using the software of the computers and the mobile phones as carriers, aiming at the office field or as a replacement for mobile phone functions, and there is no effective landing scenario combined with physical hardware products. That is, there is no interaction medium for bringing AI closer to humans, and AI cannot bring emotional value beyond basic functions to users. On the other hand, the traditional figure products focus on restoring the appearance part of the role image, and cannot restore the sound, personality, emotion and the like, and lack a deeper association of interaction with emotion. Therefore, the embodiments of the present disclosure combine an artificial intelligence technology with a figure product, so as to create an intelligent figure device and assign functions such as a memorable dialog of the figure product, to greatly simulate a timbre, a nature, and a thinking manner of a role, to greatly increase playability and an emotional interaction attribute of the figure product. That is, a product materialization form of the AI technology makes a relatively large degree of innovation, so that a practical function and an emotional value can be provided for a user. Specifically, in the embodiments of the present disclosure, the AI technologies may be hardware, instead of enabling the user to interact with the AI only in a form of the software on a computer or a mobile phone. In addition, in the embodiments of the present disclosure, “soul” may be assigned to the conventional figure, to improve association between interactivity and emotion of the figure. In addition, the AI-based intelligent interaction device in the embodiments of the present disclosure not only meets a practical function, but also can bring more emotional value and accompanying value to the user, thereby improving interactivity between the artificial intelligence product and the user, and further effectively exerting value brought by the artificial intelligence technology.

As can be seen from above in the embodiments of the present disclosure that the event information of the user interaction trigger event is obtained in response to the user interaction trigger event for the intelligent interaction device, where the profile of the intelligent interaction device is configured as the specific target role; the speech data of the target role for the user interaction trigger event is generated based on the event information by using the target language model corresponding to the target role, where the target language model is obtained through training based on both the role information and the dialog information of the target role; and the speech data is played based on the role attribute information of the target role by using the intelligent interaction device. As such, the event information of the user interaction trigger event is obtained through the intelligent interaction device whose profile is configured as a specific target role, so that the speech data of the target role for the user interaction trigger event is generated based on the event information through the target language model corresponding to the target role, and the speech data is played through the intelligent interaction device based on the role attribute information of the target role. The user interaction trigger event can be answered through the target role, thereby effectively improving the interaction effect between the user and the intelligent interaction device, improving the interactivity between the artificial intelligence product and the user, and further effectively exerting the value brought by the AI technologies.

To better implement the foregoing method, another embodiment of the present disclosure further provides a device interaction apparatus, where the device interaction apparatus may be integrated into an electronic device, and the electronic device may be a terminal.

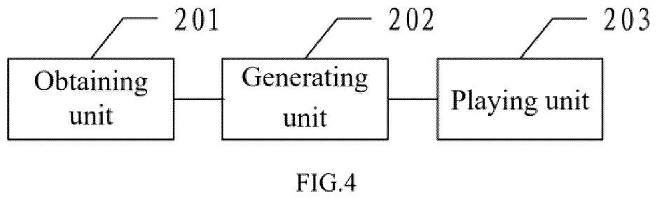

For example, as shown in FIG. 4, which is a schematic structural diagram of a device interaction apparatus according to some embodiments of the present disclosure, the device interaction apparatus may include an obtaining unit 201, a generating unit 202, and a playing unit 203 as follows.

The obtaining unit 201 is configured to obtain, in response to a user interaction trigger event for an intelligent interaction device, event information of the user interaction trigger event, where a profile of the intelligent interaction device is configured as a specific target role.

The generation unit 202 is configured to generate, by using a target language model corresponding to the target role, speech data of the target role for the user interaction trigger event based on the event information, where the target language model is obtained through training based on both role information and dialog information of the target role.

The playing unit 203 is configured to play, by using the intelligent interaction device, the speech data based on role attribute information of the target role.

In some embodiments, the user interaction trigger event includes a speech spoken by a user, and the obtaining unit 201 is configured to obtain first speech data spoken by the user; and the generating unit 202 includes: a first generating sub-unit for generating, by using the target language model corresponding to the target role, speech data for the target role responding to the first speech data based on the first speech data.

In some embodiments, the first generating sub-unit is configured to: recognize a dialog mode matching the first speech data; perform extraction of a semantic feature on the first speech data by using the target language model corresponding to the target role if the dialog mode is a chat mode, to obtain the semantic feature; and generate, by using the target language model, speech data for the target role responding to the first speech data based on the semantic feature.

In some embodiments, the first generating sub-unit is configured to: recognize a dialog mode matching the first speech data; extract instruction content in the first speech data based on the target language model corresponding to the target role if the dialog mode is an instruction mode, to generate an instruction reply speech based on the instruction content and obtain multimedia content indicated by the instruction content; and generate speech data for the target role responding to the first speech data based on the instruction reply speech and the multimedia content.

In some embodiments, the first generating sub-unit includes: a user recognizing module for determining whether the user is a target user bound to the intelligent interaction device based on the first speech data; a first generating module for generating, by using the target language model corresponding to the target role, speech data for the target role responding to the first speech data based on historical interaction data between the target user and the intelligent interaction device and the first speech data if the user is the target user; and a second generating module for generating, by using the target language model corresponding to the target role, speech data for the target role responding to the first speech data based on the first speech data if the user is not the target user.

In some embodiments, the user recognizing module is configured to: perform voiceprint recognition on the first speech data to obtain first voiceprint information; obtain second voiceprint information corresponding to the target user bound to the intelligent interaction device; and determine whether the user is the target user bound to the intelligent interaction device based on the first voiceprint information and the second voiceprint information.

In some embodiments, the device interaction apparatus further includes a sound source positioning unit, where the sound source positioning unit is configured to: perform recognition of sound source orientation on the first speech data to obtain a sound source direction of the user; and control the intelligent interaction device to face the user based on the sound source direction.

In some embodiments, the first generating sub-unit is configured to: detect device status information of the intelligent interaction device, where the device status information includes at least one of: posture information and device component assembly information of the intelligent interaction device; determine the target language model matching the device status information from a plurality of large language models for the target role; and generate, by using the target language model, speech data for the target role responding to the first speech data based on the first speech data.

In some embodiments, the user interaction trigger event includes a preset reminder event, and the obtaining unit 201 is configured to: obtain at least one object related to the reminder event and historical memory information of the intelligent interaction device for the object; and the generating unit 202 is configured to: generate, by using the target language model corresponding to the target role, speech data of the target role for the user interaction trigger event based on the object and the historical memory information.

In some embodiments, the user interaction trigger event includes an interaction action generated by the user for the intelligent interaction device, and the obtaining unit 201 is configured to obtain action information of the interaction action generated by the user for the intelligent interaction device; and the generating unit 202 is configured to: generate, by using the target language model corresponding to the target role, speech data of the target role for the user interaction trigger event based on the action information.

In some embodiments, the device interaction apparatus further includes a device control unit, where the device control unit is configured to: determine role posture information matching the speech data based on role attribute information of the target role; determine motion control information of at least one part of the intelligent interaction device and/or device control information of a sub-device on the intelligent interaction device based on the role posture information; and control the intelligent interaction device to move by using the motion control information and/or the device control information when the speech data is played by using the intelligent interaction device.

In some embodiments, the device interaction apparatus further includes a speech output prompting unit, where the speech output prompting unit is configured to: control the intelligent interaction device to perform a speech output prompt operation corresponding to a raise hand mode before the speech data is played by using the intelligent interaction device.

In some embodiments, the device interaction apparatus further includes a play interrupting unit, where the play interrupting unit is configured to: obtain second speech data generated by the user based on an interruption behavior if it is detected that the user has the interruption behavior for the speech data when the speech data is played by using the intelligent interaction device; generate, by using the target language model, target speech data for the target role responding to the second speech data based on the played data in the speech data and the second speech data; and play the target speech data by using the intelligent interaction device.

As can be seen from above in the embodiments of the present disclosure that the obtaining unit 201 obtains the event information of the user interaction trigger event in response to the user interaction trigger event for the intelligent interaction device, where the profile of the intelligent interaction device is configured as the specific target role; the generating unit 202 generates the speech data of the target role for the user interaction trigger event based on the event information by using the target language model corresponding to the target role, where the target language model is obtained through training based on both the role information and the dialog information of the target role; and the playing unit 203 plays the speech data based on the role attribute information of the target role by using the intelligent interaction device. As such, the event information of the user interaction trigger event is obtained through the intelligent interaction device whose profile is configured as a specific target role, so that the speech data of the target role for the user interaction trigger event is generated based on the event information through the target language model corresponding to the target role, and the speech data is played through the intelligent interaction device based on the role attribute information of the target role. The user interaction trigger event can be responded to through the target role, thereby effectively improving the interaction effect between the user and the intelligent interaction device, improving the interactivity between the artificial intelligence product and the user, and further effectively exerting the value brought by the AI technologies.

Correspondingly, yet another embodiment of the present disclosure further provides an electronic device, where the electronic device may be a terminal, and the terminal may be a terminal device such as a figure, a smartphone, a tablet computer, a notebook computer, a touchscreen, a game console, a personal computer (PC), or a personal digital assistant (PDA). Alternatively, the electronic device may be a server.

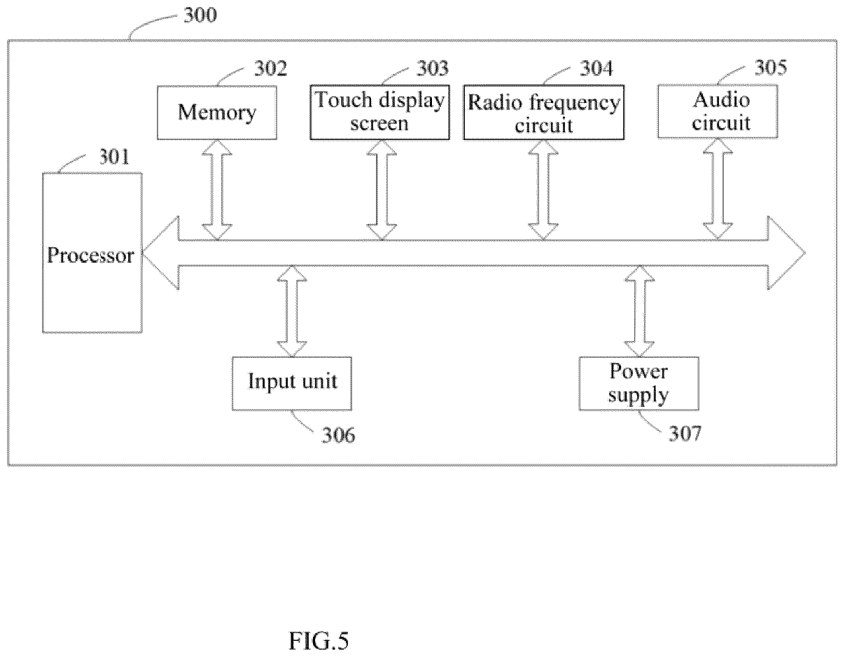

As shown in FIG. 5, which is a schematic structural diagram of an electronic device according to some embodiments of the present disclosure. The electronic device 300 includes a processor 301 having one or more processing cores, a memory 302 having one or more computer-readable storage media, and a computer program stored on the memory 302 and executable on the processor. The processor 301 is electrically connected to the memory 302. It should be understood by those skilled in the art that the structure of the electronic device shown in FIG. 5 should be not constituted to be a limitation on the electronic device, and may include more or less components than illustrated, or may combine certain components, or different component arrangements.

The processor 301 is a control center of the electronic device 300. The processor 301 is connected to various parts of the entire electronic device 300 by various interfaces and lines, and performs various functions of the electronic device 300 and processes data by running or loading software programs and/or modules stored in the memory 302 and invoking data stored in the memory 302. The processor 301 may be a processor CPU, a graphics processing unit GPU, a network processor (NP), or the like, and may implement or perform the methods, steps, and logical block diagrams disclosed in the embodiments of the present disclosure.

In the embodiments of the present disclosure, the processor 301 in the electronic device 300 loads instructions corresponding to processes of one or more application programs into the memory 302 according to the following steps, and the processor 301 executes the application programs stored in the memory 302 to implement various functions, for example: obtaining, in response to the user interaction trigger event for the intelligent interaction device, the event information of the user interaction trigger event, where the profile of the intelligent interaction device is configured as the specific target role; generating the speech data of the target role for the user interaction trigger event based on the event information by using the target language model corresponding to the target role, where the target language model is obtained through training based on both the role information and the dialog information of the target role; and playing the speech data based on the role attribute information of the target role by using the intelligent interaction device.

In the solution, the event information of the user interaction trigger event may be obtained in response to the user interaction trigger event for the intelligent interaction device, where the profile of the intelligent interaction device is configured as the specific target role; the speech data of the target role for the user interaction trigger event may be generated based on the event information by using the target language model corresponding to the target role, where the target language model is obtained through training based on both the role information and the dialog information of the target role; and the speech data may be played based on the role attribute information of the target role by using the intelligent interaction device. As such, the event information of the user interaction trigger event is obtained through the intelligent interaction device whose profile is configured as a specific target role, so that the speech data of the target role for the user interaction trigger event is generated based on the event information through the target language model corresponding to the target role, and the speech data is played through the intelligent interaction device based on the role attribute information of the target role. The user interaction trigger event can be answered through the target role, thereby effectively improving the interaction effect between the user and the intelligent interaction device, improving the interactivity between the artificial intelligence product and the user, and further effectively exerting the value brought by the AI technologies.

Further, various functions implemented by running the application program stored in the memory 302 may further refer to the descriptions in the foregoing embodiments, which is not repeatedly described again herein.

Implementation of above operations may refer to above embodiments, and is not repeated herein.

Alternatively, as shown in FIG. 5, the electronic device 300 further includes a touch display screen 303, a radio frequency circuit 304, an audio circuit 305, an input unit 306, and a power supply 307. The processor 301 is electrically connected to the touch display screen 303, the radio frequency circuit 304, the audio circuit 305, the input unit 306, and the power supply 307, respectively. It should be understood by those skilled in the art that the structure of the electronic device shown in FIG. 5 should be not constituted to be a limitation on the electronic device, and may include more or less components than illustrated, or may combine certain components, or different component arrangements.

The touch display screen 303 may be configured to display a graphical user interface and receive an operation instruction generated by a user acting on the graphical user interface. The touch display screen 303 may include a display panel and a touch panel. The display panel may be used to display information input by the user or information provided to the user and various graphical user interfaces of the electronic device, and these graphical user interfaces may be composed of graphics, texts, icons, videos and any combination thereof. Alternatively, the display panel may be configured in a form of a liquid crystal display (LCD), an organic light-emitting diode (OLED), or the like. The touch panel may be configured to collect a touch operation performed by the user on or near the touch panel (for example, an operation is performed by the user on or near the touch panel by using any suitable object or accessory such as a finger or a stylus), and generate a corresponding operation instruction, where the operation instruction is configured to execute a corresponding program. Alternatively, the touch panel may include two parts: a touch detection apparatus and a touch controller. The touch detection device detects the touch direction of the user, detects a signal caused by the touch operation, and transmits the signal to the touch controller. The touch controller receives touch information from the touch detection device, converts the touch information into a contact coordinate, and then transmits the contact coordinate to the processor 301 and can receive a command transmitted by the processor 301 and execute the command. The touch panel can cover the display panel when the touch panel detects a touch operation on or near it, the signal caused by the touch operation is transmitted to the processor 301 to determine the type of a touch event. Then, the processor 301 provides a corresponding visual output on the display panel according to the type of the touch event. In the embodiments of the present disclosure, the touch panel and the display panel may be integrated into the touch display screen 303 to implement input and output functions. However, in some embodiments, the touch panel and the display panel may be used as two independent components to implement input and output functions. That is, the touch display screen 303 may also implement an input function as a part of the input unit 306.

The radio frequency circuit 304 may be configured to transmit and receive a radio frequency signal, to establish wireless communication with a network device or another electronic device through wireless communication, and transmit and receive a signal with the network device or the another electronic device.

The audio circuit 305 may be configured to provide an audio interface between a user and the electronic device through a speaker and a microphone. The audio circuit 305 may convert received audio data to an electrical signal and transmit the electrical signal to the speaker. The speaker converts the electrical signal to sound signals and outputs the sound signals. In addition, the microphone converts collected sound signal to an electrical signal. The audio circuit 305 converts the electrical signal to audio data and transmits the audio data to the processor 301 for further processing. After the processing, the audio data may be transmitted to another electronic device via the radio frequency circuit 304, or transmitted to the memory 302 for further processing. The audio circuit 305 may further include an earplug jack to provide communication between a peripheral earphone and the electronic device.

The input unit 306 may be configured to receive an input target video, and generate a keyboard, mouse, joystick, optical, or track ball signal input related to user setting and function control.

The power supply 307 is configured to supply power to components of the electronic device 300. Alternatively, the power supply 307 may be logically connected to the processor 301 by using a power management system, to manage functions such as charging, discharging, and power consumption management by using the power management system. The power supply 307 may further include one or more direct current (DC)/or alternating current (AC) power sources, recharging system, power failure detection circuit, power converter or inverter, power supply status indicator, and the like.

Although not shown in FIG. 5, the electronic device 300 may further include a camera, a sensor, a wireless fidelity module, a Bluetooth module, and the like, which are not repeatedly described herein again.

In the foregoing embodiments, descriptions of the embodiments are emphasized. A portion that is not described in detail in an embodiment may refer to related descriptions in another embodiment. It should be noted that the electronic device provided in the embodiments of the present disclosure and the device interaction method applicable to the foregoing embodiments belong to a same concept, and a specific implementation process for the electronic device may refer to the foregoing method embodiments, which are not repeatedly described herein again.

As can be seen from above in the embodiments of the present disclosure that the electronic device can obtain the event information of the user interaction trigger event in response to the user interaction trigger event for the intelligent interaction device, where the profile of the intelligent interaction device is configured as the specific target role; generate the speech data of the target role for the user interaction trigger event based on the event information by using the target language model corresponding to the target role, where the target language model is obtained through training based on both the role information and the dialog information of the target role; and play the speech data based on the role attribute information of the target role by using the intelligent interaction device. As such, the event information of the user interaction trigger event is obtained through the intelligent interaction device whose profile is configured as a specific target role, so that the speech data of the target role for the user interaction trigger event is generated based on the event information through the target language model corresponding to the target role, and the speech data is played through the intelligent interaction device based on the role attribute information of the target role. The user interaction trigger event can be answered through the target role, thereby effectively improving the interaction effect between the user and the intelligent interaction device, improving the interactivity between the artificial intelligence product and the user, and further effectively exerting the value brought by the AI technologies.

A person of ordinary skill in the art may understand that all or some of the steps in various methods of the foregoing embodiments may be implemented by program instructions, or may be implemented by a program instructing relevant hardware. The program instructions may be stored in a computer readable storage medium, and be loaded and executed by a processor.

Therefore, yet another embodiment of the present disclosure provides a non-transitory computer-readable storage medium, including a computer program, where when the computer program is run on an electronic device, the computer program is used to cause the electronic device to perform any device interaction method provided in the embodiments of the present disclosure. For example, the computer program may perform following steps of the device interaction method: obtaining, in response to the user interaction trigger event for the intelligent interaction device, the event information of the user interaction trigger event, where the profile of the intelligent interaction device is configured as the specific target role; generating the speech data of the target role for the user interaction trigger event based on the event information by using the target language model corresponding to the target role, where the target language model is obtained through training based on both the role information and the dialog information of the target role; and playing the speech data based on the role attribute information of the target role by using the intelligent interaction device.

In the solution, the event information of the user interaction trigger event may be obtained in response to the user interaction trigger event for the intelligent interaction device, where the profile of the intelligent interaction device is configured as the specific target role; the speech data of the target role for the user interaction trigger event may be generated based on the event information by using the target language model corresponding to the target role, where the target language model is obtained through training based on both the role information and the dialog information of the target role; and the speech data may be played based on the role attribute information of the target role by using the intelligent interaction device. As such, the event information of the user interaction trigger event is obtained through the intelligent interaction device whose profile is configured as a specific target role, so that the speech data of the target role for the user interaction trigger event is generated based on the event information through the target language model corresponding to the target role, and the speech data is played through the intelligent interaction device based on the role attribute information of the target role. The user interaction trigger event can be responded to through the target role, thereby effectively improving the interaction effect between the user and the intelligent interaction device, improving the interactivity between the artificial intelligence product and the user, and further effectively exerting the value brought by the AI technologies.

Further, detailed steps of the foregoing method steps may further refer to the descriptions in the foregoing embodiments, which are not repeatedly described again herein.

Implementation of above operations may refer to above embodiments, which are not repeatedly described again herein.

The computer readable storage medium may include a Read Only Memory (ROM), a Random Access Memory (RAM), a magnetic disk, an optical disk, or the like.

Since the computer program stored in the computer-readable storage medium can perform the steps in any of the device interaction methods provided in the embodiments of the present disclosure, the advantageous effects achieved by the any of the device interaction methods provided in the embodiments of the present disclosure can be realized. Please refer to the foregoing embodiments, of which details are not repeatedly described herein.

According to an aspect of the present disclosure, a computer program product is further provided, including a computer program, where the computer program is stored in a computer-readable storage medium; and when a processor of an electronic device reads the computer program from the computer-readable storage medium, the processor executes the computer program to cause the electronic device to perform the method provided in various alternative implementations in the foregoing embodiments.

In the foregoing embodiments of the device interaction apparatus, the computer-readable storage medium, the electronic device, and the computer program product, descriptions of the embodiments are emphasized. A portion that is not described in detail in an embodiment may refer to related descriptions in another embodiment. It will be clearly apparent to those skilled in the art that, for the convenience and brevity of the description, specific working processes and beneficial effects of the device interaction apparatus, the computer-readable storage medium, the computer program product, the electronic device, and the corresponding units thereof described above may refer to, reference may be made to the description of the device interaction method in the foregoing embodiments, which are not repeatedly described herein again.

The device interaction method and apparatus, the electronic device, the computer-readable storage medium and the computer program product provided by the embodiments of the present disclosure are described in detail above. A specific example is used herein to describe a principle and an implementation of the present disclosure. The description of the foregoing embodiments is merely used to help understand a method and a core idea of the present disclosure. In addition, an ordinary person skilled in the art may make changes in a specific implementation manner and an application scope according to an idea of the present disclosure. In conclusion, content of this specification should not be construed as a limitation on the present disclosure.

What is claimed is:

1. A device interaction method, comprising:
obtaining, in response to a user interaction trigger event for an intelligent interaction device, event information of the user interaction trigger event, wherein a profile of the intelligent interaction device is configured as a specific target role;
generating, by using a target language model corresponding to the target role, speech data of the target role for the user interaction trigger event based on the event information, wherein the target language model is obtained through training based on both role information and dialog information of the target role; and
playing, by using the intelligent interaction device, the speech data based on role attribute information of the target role.

2. The device interaction method of claim 1, wherein the user interaction trigger event comprises a speech spoken by a user, and the obtaining of the event information of the user interaction trigger event comprises obtaining first speech data spoken by the user; and
the generating of the speech data of the target role for the user interaction trigger event comprises generating, by using the target language model corresponding to the target role, speech data for the target role responding to the first speech data based on the first speech data.

3. The device interaction method of claim 2, wherein the generating of the speech data for the target role responding to the first speech data comprises:
recognizing a dialog mode matching the first speech data;
performing, by using the target language model corresponding to the target role, extraction of a semantic feature on the first speech data in response to the dialog mode being a chat mode, to obtain the semantic feature; and
generating, by using the target language model, speech data for the target role responding to the first speech data based on the semantic feature.

4. The device interaction method of claim 2, wherein the generating of the speech data for the target role responding to the first speech data comprises:
recognizing a dialog mode matching the first speech data;
extracting instruction content in the first speech data based on the target language model corresponding to the target role in response to the dialog mode being an instruction mode, to generate an instruction reply speech based on the instruction content and obtain multimedia content indicated by the instruction content; and
generating speech data for the target role responding to the first speech data based on the instruction reply speech and the multimedia content.

5. The device interaction method of claim 2, wherein the generating of the speech data for the target role responding to the first speech data comprises:
determining whether the user is a target user bound to the intelligent interaction device based on the first speech data;
generating, by using the target language model corresponding to the target role, speech data for the target role responding to the first speech data based on historical interaction data between the target user and the intelligent interaction device and the first speech data in response to the user being the target user; and
generating, by using the target language model corresponding to the target role, speech data for the target role responding to the first speech data based on the first speech data in response to the user being not the target user.

6. The device interaction method of claim 5, wherein the determining of whether the user is the target user bound to the intelligent interaction device based on the first speech data comprises:
performing voiceprint recognition on the first speech data to obtain first voiceprint information;
obtaining second voiceprint information corresponding to the target user bound to the intelligent interaction device; and
determining whether the user is the target user bound to the intelligent interaction device based on the first voiceprint information and the second voiceprint information.

7. The device interaction method of claim 2, further comprising:
performing recognition of sound source orientation on the first voice data to obtain a sound source direction of the user; and
controlling the intelligent interaction device to face the user based on the sound source direction.

8. The device interaction method of claim 2, wherein the generating of the speech data for the target role responding to the first speech data comprises:
detecting device status information of the intelligent interaction device, wherein the device status information comprises at least one of: posture information and device component assembly information of the intelligent interaction device;
determining a target language model matching the device status information from a plurality of large language models for the target role; and
generating, by using the target language model, speech data for the target role responding to the first speech data based on the first speech data.

9. The device interaction method of claim 1, wherein the user interaction trigger event comprises a preset reminder event, and the obtaining of the event information of the user interaction trigger event comprises obtaining at least one object related to the reminder event and historical memory information of the intelligent interaction device for the object; and
the generating of the speech data of the target role for the user interaction trigger event comprises generating, by using the target language model corresponding to the target role, speech data of the target role for the user interaction trigger event based on the object and the historical memory information.

10. The device interaction method of claim 1, wherein the user interaction trigger event comprises an interaction action generated by the user for the intelligent interaction device, and the obtaining of the event information of the user interaction trigger event comprises: obtaining action information of the interaction action generated by the user for the intelligent interaction device; and
the generating of the speech data of the target role for the user interaction trigger event comprises generating, by using the target language model corresponding to the target role, speech data of the target role for the user interaction trigger event based on the action information.

11. The device interaction method of claim 1, further comprising:
determining role posture information matching the speech data based on role attribute information of the target role;
determining at least one of motion control information of at least one part of the intelligent interaction device and device control information of a sub-device on the intelligent interaction device based on the role posture information; and
controlling the intelligent interaction device to move by using the at least one of the motion control information and the device control information when the speech data is played by using the intelligent interaction device.

12. The device interaction method of claim 2, further comprising:
determining role posture information matching the speech data based on role attribute information of the target role;
determining at least one of motion control information of at least one part of the intelligent interaction device and device control information of a sub-device on the intelligent interaction device based on the role posture information; and
controlling the intelligent interaction device to move by using the at least one of the motion control information and the device control information when the speech data is played by using the intelligent interaction device.

13. The device interaction method of claim 3, further comprising:
determining role posture information matching the speech data based on role attribute information of the target role;
determining at least one of motion control information of at least one part of the intelligent interaction device and device control information of a sub-device on the intelligent interaction device based on the role posture information; and
controlling the intelligent interaction device to move by using the at least one of the motion control information and the device control information when the speech data is played by using the intelligent interaction device.

14. The device interaction method of claim 4, further comprising:
determining role posture information matching the speech data based on role attribute information of the target role;
determining at least one of motion control information of at least one part of the intelligent interaction device and device control information of a sub-device on the intelligent interaction device based on the role posture information; and
controlling the intelligent interaction device to move by using the at least one of the motion control information and the device control information when the speech data is played by using the intelligent interaction device.

15. The device interaction method of claim 5, further comprising:
determining role posture information matching the speech data based on role attribute information of the target role;
determining at least one of motion control information of at least one part of the intelligent interaction device and device control information of a sub-device on the intelligent interaction device based on the role posture information; and
controlling the intelligent interaction device to move by using the at least one of the motion control information and the device control information when the speech data is played by using the intelligent interaction device.

16. The device interaction method of claim 6, further comprising:
determining role posture information matching the speech data based on role attribute information of the target role;
determining at least one of motion control information of at least one part of the intelligent interaction device and device control information of a sub-device on the intelligent interaction device based on the role posture information; and
controlling the intelligent interaction device to move by using the at least one of the motion control information and the device control information when the speech data is played by using the intelligent interaction device.

17. The device interaction method of claim 1, further comprising:
controlling the intelligent interaction device to perform a speech output prompt operation corresponding to a raise hand mode before the speech data is played by using the intelligent interaction device.

18. The device interaction method of claim 1, further comprising:
obtaining second speech data generated by the user based on an interruption behavior if it is detected that the user has the interruption behavior for the speech data when the speech data is played by using the intelligent interaction device;
generating, by using the target language model, target speech data for the target role responding to the second speech data based on played data in the speech data and the second speech data; and
playing the target speech data by using the intelligent interaction device.

19. An electronic device, comprising a processor and a memory, wherein the memory is stored with a computer program, and when the computer program is executed by the processor, the processor is enabled to perform a device interaction method, comprising:
obtaining, in response to a user interaction trigger event for an intelligent interaction device, event information of the user interaction trigger event, wherein a profile of the intelligent interaction device is configured as a specific target role;
generating, by using a target language model corresponding to the target role, speech data of the target role for the user interaction trigger event based on the event information, wherein the target language model is obtained through training based on both role information and dialog information of the target role; and
playing, by using the intelligent interaction device, the speech data based on role attribute information of the target role.

20. A non-transitory computer-readable storage medium, comprising a computer program, wherein when the computer program is run on an electronic device, the computer program is configured to cause the electronic device to perform a device interaction method, comprising:
obtaining, in response to a user interaction trigger event for an intelligent interaction device, event information of the user interaction trigger event, wherein a profile of the intelligent interaction device is configured as a specific target role;
generating, by using a target language model corresponding to the target role, speech data of the target role for the user interaction trigger event based on the event information, wherein the target language model is obtained through training based on both role information and dialog information of the target role; and
playing, by using the intelligent interaction device, the speech data based on role attribute information of the target role.
